(19) United States
(12) Patent Application Publication
(10) Pub. No.: US 2026/0369792 A1
(43) Pub. Date: Nov. 19, 2026

(54) EMBEDDED BATTERY CARTRIDGE

(71) Applicant: CHENG UEI PRECISION INDUSTRY CO., LTD., New Taipei City (TW)

(72) Inventor: TSUNG-SHIH LEE, New Taipei City (TW)

(21) Appl. No.: 19/324,133

(22) Filed: Sep. 10, 2025

(30) Foreign Application Priority Data
May 15, 2025 (CN) 202520962567.0

(51) Int. Cl. H01M 50/273; H01M 50/233; H01M 50/244

(52) U.S. Cl. CPC H01M 50/273; H01M 50/233; H01M 50/244

(57) ABSTRACT

An embedded battery cartridge includes a battery holder, a first assembling hole penetrating through the battery holder along a front-rear direction, a second assembling hole penetrating through the battery holder along the front-rear direction, a first buckling block protruding into the first assembling hole, a second buckling block protruding into the second assembling hole, a battery cover detachably fastened to a front of the battery holder, a first elastic buckling portion and a second elastic buckling portion. The first elastic buckling portion is protruded inward from an inner wall of the battery cover. The first elastic buckling portion is buckled in the first assembling hole. The second elastic buckling portion is protruded inward from the inner wall of the battery cover. The second elastic buckling portion is buckled in the second assembling hole.

### CROSS REFERENCE TO RELATED APPLICATIONS

The present application is based on, and claims priority from, China Patent Application No. 202520962567.0, filed May 15, 2025, the disclosure of which is hereby incorporated by reference herein in its entirety.

### BACKGROUND OF THE INVENTION

### Field of the Invention

The present invention generally relates to an embedded battery cartridge, and more particularly to an embedded battery cartridge capable of disposing positions more flexibly.

### Description of Related Art

Referring to FIG. 14, many miniaturized electronic devices adopt replaceable batteries to provide a power supply. Each miniaturized electronic device has a battery holder for accommodating the battery, and a detachably conventional battery cover 50 for protecting the battery. In order to make the conventional battery cover 50 stably combined with the battery holder, the conventional battery cover 50 has a fastening hook 51 and a retaining tenon 52 respectively located at two opposite sides of the conventional battery cover 50.

However, with a product appearance design evolution, a position of the battery holder and a shape of the conventional battery cover 50 become more diverse. Conventionally, each of the fastening hook 51 and the retaining tenon 52 just limit a single moving direction of the conventional battery cover 50. Disposing positions of the fastening hook 51 and the retaining tenon 52 are respectively corresponding to different sides of the conventional battery cover 50, the conventional battery cover 50 is fastened to the battery cartridge, so that a combination of the fastening hook 51 and the retaining tenon 52 have no way of flexibly adjusting the disposing positions according to the product appearance design.

Thus, it is essential to provide an innovative embedded battery cartridge. The innovative embedded battery cartridge capable of disposing positions more flexibly, and the innovative embedded battery cartridge is capable of being applied in various devices with different appearances.

### BRIEF SUMMARY OF THE INVENTION

An object of the present invention is to provide an embedded battery cartridge integrated into an electronic device. The embedded battery cartridge includes a battery holder, and a battery cover detachably fastened to the battery holder. An outer surface of the battery holder is recessed inward to form a receiving space. The battery holder opens a first assembling hole disposed at a left side of the battery holder, and a second assembling hole disposed at a right side of the battery holder. The first assembling hole penetrates through the battery holder along a front-rear direction. The second assembling hole penetrates through the battery holder along the front-rear direction. The first assembling hole is surrounded by a top wall, a bottom wall opposite to the top wall, a left side wall and a right side wall opposite to each other. The second assembling hole is surrounded by an upper wall, a lower wall opposite to the upper wall, a left lateral wall and a right lateral wall opposite to each other. The battery holder defines a first buckling block protruded inward from a middle of an inner surface of the left side wall of the first assembling hole. The battery holder defines a second buckling block protruded inward from a middle of an inner surface of the right lateral wall of the second assembling hole. A rear surface of the top wall of the first assembling hole is recessed inward and frontward to form a recess. The recess extends to a top of the first assembling hole. The recess is communicated with the first assembling hole. The battery cover covers the receiving space. An inside of the battery cover has an inner wall. The battery cover has a first elastic buckling portion and a second elastic buckling portion protruded inward from the inner wall of the battery cover. The first elastic buckling portion has a buckling arm extended inward from the inner wall of the battery cover, and a limiting arm extended upward from a tail end of the buckling arm. The buckling arm is fastened between the first buckling block and the top wall of the first assembling hole. The limiting arm is limited in the recess. The second elastic buckling portion has an outer surface and a bottom surface. A middle of the outer surface of the second elastic buckling portion is recessed inward to form a clamping slot penetrating through the bottom surface. The second buckling block has a long protruding block disposed along an up-down direction, and a short protruding block extended frontward from a front of a lower portion of the long protruding block. The long protruding block of the second buckling block is buckled in the clamping slot. The short protruding block tightly abuts against the bottom surface of the second elastic buckling portion.

Another object of the present invention is to provide an embedded battery cartridge. The embedded battery cartridge includes a battery holder, a first assembling hole disposed at a left side of the battery holder, a second assembling hole disposed at a right side of the battery holder, a first buckling block, a second buckling block, a recess, a battery cover, a first elastic buckling portion and a second elastic buckling portion. The first assembling hole penetrates through the battery holder along a front-rear direction. The second assembling hole penetrates through the battery holder along the front-rear direction. The first buckling block is protruded inward from an inner surface of a left side wall of the first assembling hole. The second buckling block is protruded inward from an inner peripheral wall of the second assembling hole, and the second buckling block protrudes into the second assembling hole. A rear surface of a top wall of the first assembling hole is recessed inward and frontward to form the recess extending to a top of the first assembling hole. The recess is communicated with the first assembling hole. The battery cover is detachably fastened to a front of the battery holder. An inside of the battery cover has an inner wall. The first elastic buckling portion is protruded inward from the inner wall of the battery cover. The first elastic buckling portion has a limiting groove recessed downward from an inner portion of a top of the first elastic buckling portion. The second elastic buckling portion is protruded inward from the inner wall of the battery cover. The first elastic buckling portion is buckled in the first assembling hole, a bottom of the first elastic buckling portion abuts against the first buckling block, and the top of the first elastic buckling portion is buckled in the recess. The second elastic buckling portion is buckled in the second assembling hole, a bottom of the second elastic buckling portion abuts against the second buckling block.

Another object of the present invention is to provide an embedded battery cartridge. The embedded battery cartridge includes a battery holder, a first assembling hole penetrating through the battery holder along a front-rear direction, a second assembling hole penetrating through the battery holder along the front-rear direction, a first buckling block, a second buckling block, a recess, a battery cover detachably fastened to a front of the battery holder, a first elastic buckling portion and a second elastic buckling portion. The first buckling block is protruded inward from an inner peripheral wall of the first assembling hole, and the first buckling block protrudes into the first assembling hole. The second buckling block is protruded inward from an inner peripheral wall of the second assembling hole, and the second buckling block protrudes into the second assembling hole. A rear surface of a top wall of the first assembling hole is recessed inward and frontward to form the recess extending to a top of the first assembling hole. The recess is communicated with the first assembling hole. The first elastic buckling portion is protruded inward from an inner wall of the battery cover. The first elastic buckling portion is buckled in the first assembling hole. The first elastic buckling portion has a buckling arm extended inward from the inner wall of the battery cover, and a limiting arm extended upward from a tail end of the buckling arm. The buckling arm is fastened between the first buckling block and the top wall of the first assembling hole. The limiting arm is limited in the recess. The second elastic buckling portion is protruded inward from the inner wall of the battery cover. The second elastic buckling portion is buckled in the second assembling hole. A bottom of the second elastic buckling portion abuts against the second buckling block.

As described above, the first elastic buckling portion and the second elastic buckling portion of the inner wall of the battery cover, the first assembling hole having the first buckling block, and the second assembling hole having the second buckling block are defined as fastening structures, so a combination of the first elastic buckling portion and the first assembling hole, and a combination of the second elastic buckling portion and the second assembling hole limit movements of the battery cover along multiple directions. Furthermore, the combination of the first elastic buckling portion and the first assembling hole, and the combination of the second elastic buckling portion and the second assembling hole are without being limited to be disposed to other positions of the embedded battery cartridge which are different from the embedded battery cartridge according to the present invention, so the embedded battery cartridge flexibly adjusts a disposing position of the combination of the first elastic buckling portion and the first assembling hole, and a disposing position of the combination of the second elastic buckling portion and the second assembling hole according to a need of the electronic device to appropriate for different appearances of the electronic devices. As a result, the embedded battery cartridge is capable of disposing positions more flexibly.

### BRIEF DESCRIPTION OF THE DRAWINGS

The present invention will be apparent to those skilled in the art by reading the following description, with reference to the attached drawings, in which:

FIG. 1 is an exploded view of an electronic device with an embedded battery cartridge according to the present invention;

FIG. 2 is an enlarged view of an encircled portion X of the embedded battery cartridge of FIG. 1;

FIG. 3 is an enlarged view of an encircled portion Y of the embedded battery cartridge of FIG. 1;

FIG. 4 is a perspective view of a battery cover of the embedded battery cartridge according to the present invention;

FIG. 5 is an enlarged view of an encircled portion Z1 of the battery cover of the embedded battery cartridge of FIG. 4;

FIG. 6 is an enlarged view of an encircled portion Z2 of the battery cover of the embedded battery cartridge of FIG. 4;

FIG. 7 is a front view of the embedded battery cartridge, wherein a first elastic buckling portion is incompletely buckled to a first assembling hole of the embedded battery cartridge according to the present invention;

FIG. 8 is a front view of the embedded battery cartridge, wherein a second elastic buckling portion is incompletely buckled to a second assembling hole of the embedded battery cartridge according to the present invention;

FIG. 9 is a front view of the embedded battery cartridge, wherein the first elastic buckling portion is completely buckled to the first assembling hole of the embedded battery cartridge according to the present invention;

FIG. 10 is a front view of the embedded battery cartridge, wherein the second elastic buckling portion is completely buckled to the second assembling hole of the embedded battery cartridge according to the present invention;

FIG. 11 is a front assembling view of the embedded battery cartridge according to the present invention;

FIG. 12 is a partial sectional view of the embedded battery cartridge along a line A-A of FIG. 11;

FIG. 13 is a partial sectional view of the embedded battery cartridge along a line B-B of FIG. 11; and

FIG. 14 is a perspective view of a conventional battery cover in prior art.

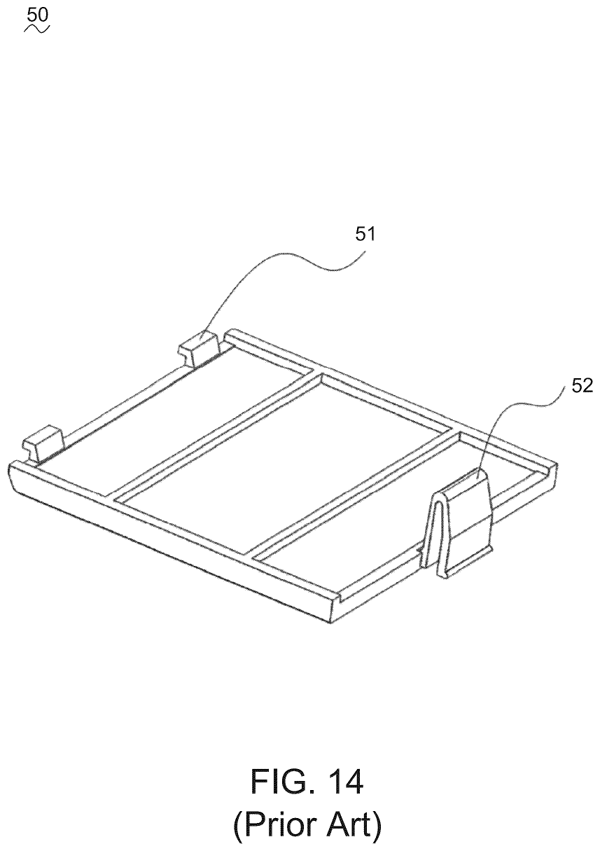

### DETAILED DESCRIPTION OF THE INVENTION

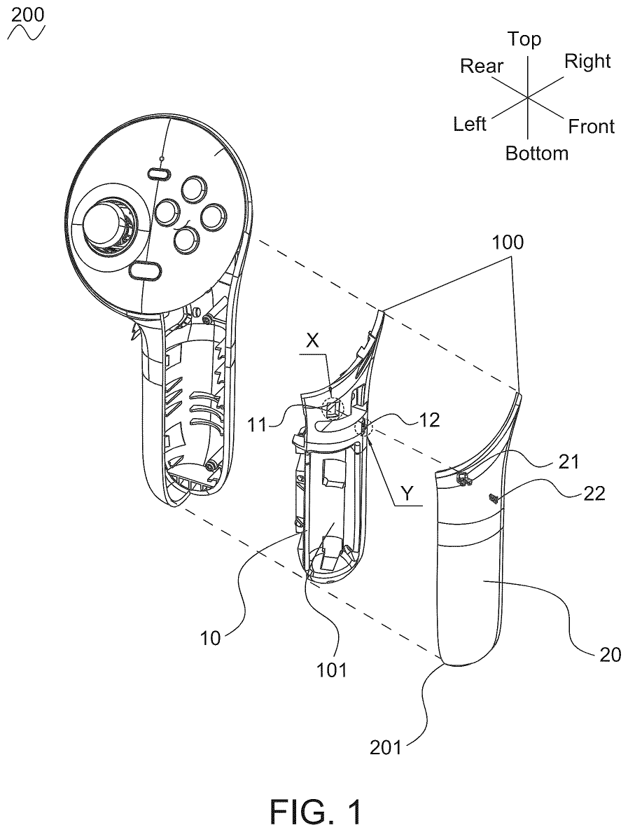

With reference to FIG. 1 to FIG. 3, an embedded battery cartridge 100 according to a preferred embodiment of the present invention is shown. The embedded battery cartridge 100 is integrated into an electronic device 200. The embedded battery cartridge 100 is defined as a part of an outer shell 201 of the electronic device 200. The embedded battery cartridge 100 includes a battery holder 10 and a battery cover 20. An inside of the battery holder 10 is hollow. An outer surface of the battery holder 10 is recessed inward to form a receiving space 101. The battery cover 20 is detachably fastened to the front of the battery holder 10. The battery cover 20 covers the receiving space 101.

Referring to FIG. 1 to FIG. 4, the battery holder 10 opens a first assembling hole 11 disposed at a left side of the battery holder 10, and a second assembling hole 12 disposed at a right side of the battery holder 10. Specifically, the battery holder 10 opens a first assembling hole 11 at a left top portion of the battery holder 10, and a second assembling hole 12 at a right top portion of the battery holder 10. The first assembling hole 11 penetrates through the battery holder 10 along a front-rear direction. The second assembling hole 12 penetrates through the battery holder 10 along the front-rear direction. The first assembling hole 11 and the second assembling hole 12 are located above the receiving space 101. The second assembling hole 12 is located below the first assembling hole 11. The battery cover 20 has a first elastic buckling portion 21 protruded rearward from a left top portion of a rear surface of the battery cover 20, and a second elastic buckling portion 22 protruded rearward from a right top portion of the rear surface of the battery cover 20. The first elastic buckling portion 21 is matched with the first assembling hole 11. The second elastic buckling portion 22 is matched with the second assembling hole 12.

A left side of the battery holder 10 defines a first buckling block 111. The first buckling block 111 is protruded inward from an inner peripheral wall of the first assembling hole 11, and the first buckling block 111 protrudes into the first assembling hole 11. A right side of the battery holder 10 defines a second buckling block 121. The second buckling block 121 is protruded inward from an inner peripheral wall of the second assembling hole 12, and the second buckling block 121 protrudes into the second assembling hole 12. When the battery cover 20 is completed being assembled to the battery holder 10, the first elastic buckling portion 21 is locked in the first assembling hole 11, and the second elastic buckling portion 22 is locked in the second assembling hole 12, so that the battery cover 20 is fastened to the battery holder 10.

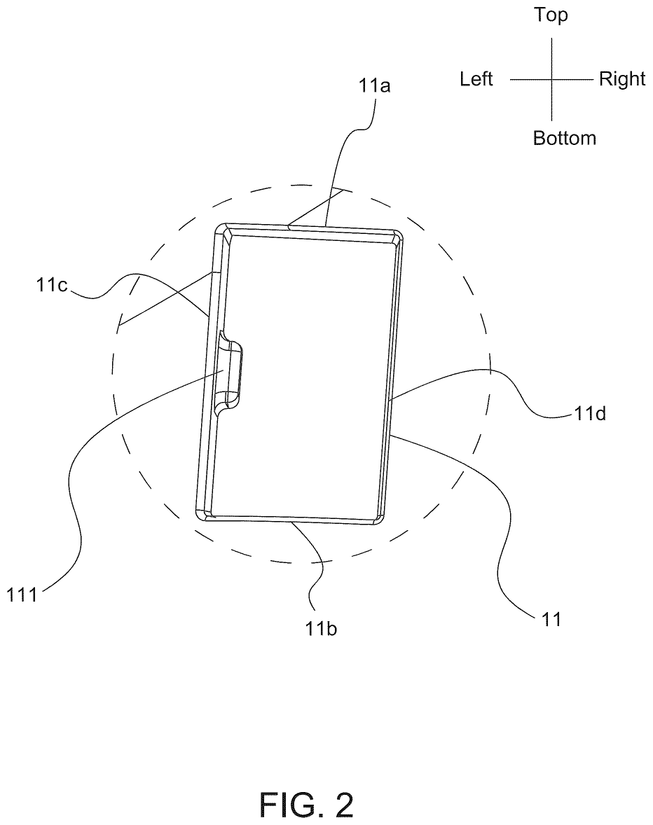

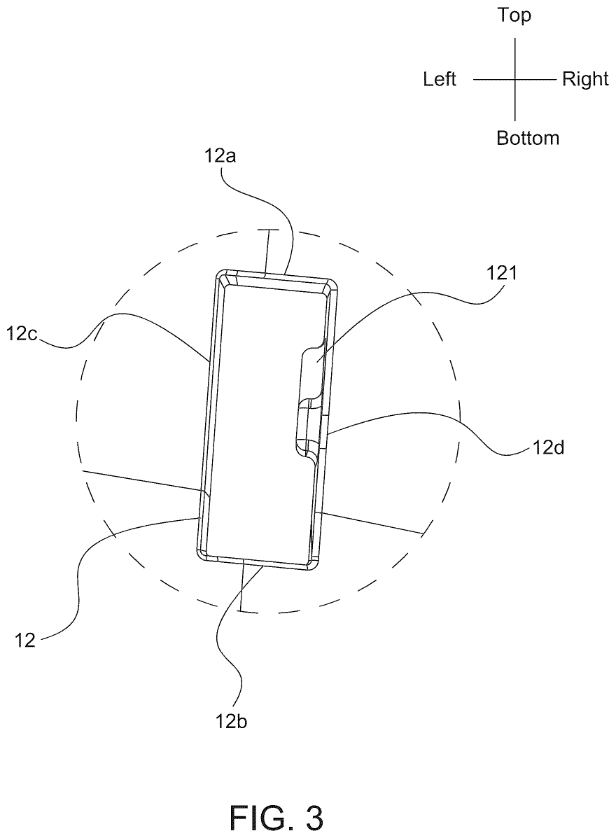

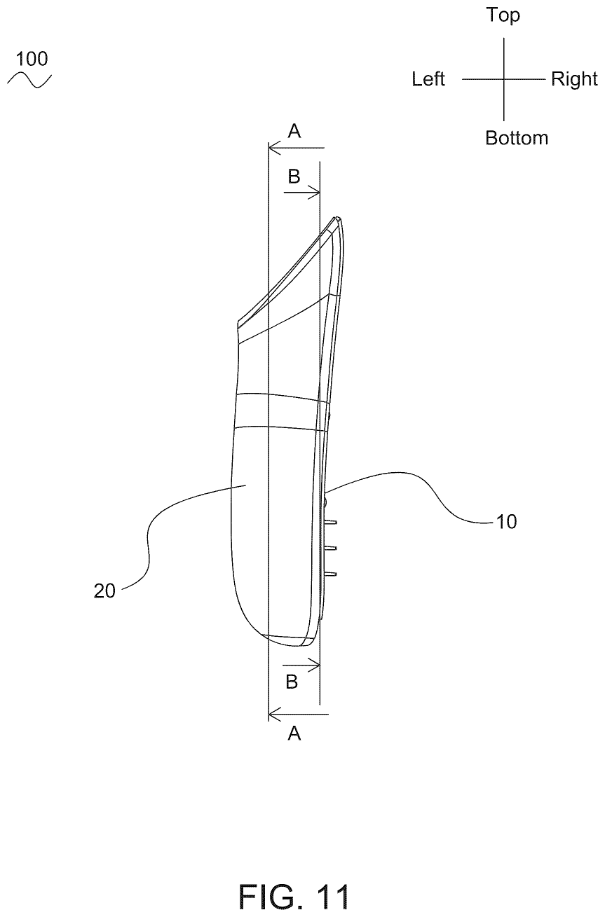

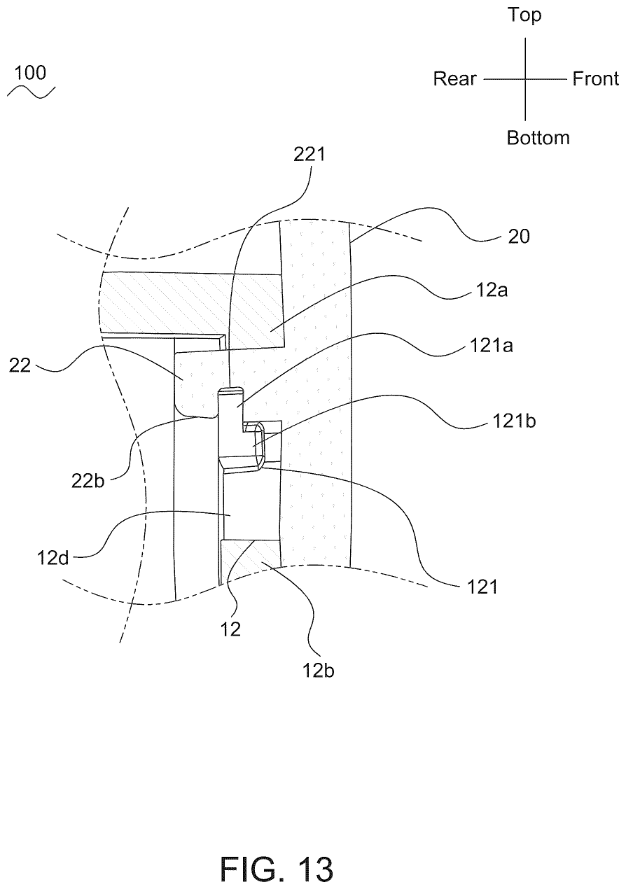

Referring to FIG. 2, FIG. 3, FIG. 11 and FIG. 13, the first assembling hole 11 is surrounded by a top wall 11a, a bottom wall 11b opposite to the top wall 11a, a left side wall 11c connected between one sides of the top wall 11a and the bottom wall 11b, and a right side wall 11d connected between the other sides of the top wall 11a and the bottom wall 11b. The left side wall 11c and the right side wall 11d are opposite to each other. The second assembling hole 12 is surrounded by an upper wall 12a, a lower wall 12b opposite to the upper wall 12a, a left lateral wall 12c connected between one sides of the upper wall 12a and the lower wall 12b, and a right lateral wall 12d connected between the other sides of the upper wall 12a and the lower wall 12b. The left lateral wall 12c and the right lateral wall 12d are opposite to each other. The first buckling block 111 is protruded inward from a middle of an inner surface of the left side wall 11c of the first assembling hole 11. The second buckling block 121 is protruded inward from a middle of an inner surface of the right lateral wall 12d of the second assembling hole 12.

In the preferred embodiment, a rear surface of the top wall 11a of the first assembling hole 11 is recessed inward and frontward to form a recess 112. The recess 112 extends to a top of the first assembling hole 11. The recess 112 is communicated with the first assembling hole 11. A shape of the recess 112 is similar to a shape of a top end of the first elastic buckling portion 21. The second buckling block 121 is shown as an L shape. The second buckling block 121 has a long protruding block 121a disposed along an up-down direction, and a short protruding block 121b disposed along the front-rear direction. The long protruding block 121a is substantially perpendicular to the short protruding block 121b. The long protruding block 121a is protruded inward from the inner surface of the right lateral wall 12d of the second assembling hole 12. The short protruding block 121b is protruded inward from the inner surface of the right lateral wall 12d of the second assembling hole 12. The long protruding block 121a extends along the up-down direction. The short protruding block 121b is extended frontward from a front of a lower portion of the long protruding block 121a. The short protruding block 121b extends from inside to outside. The long protruding block 121a is perpendicular to the short protruding block 121b.

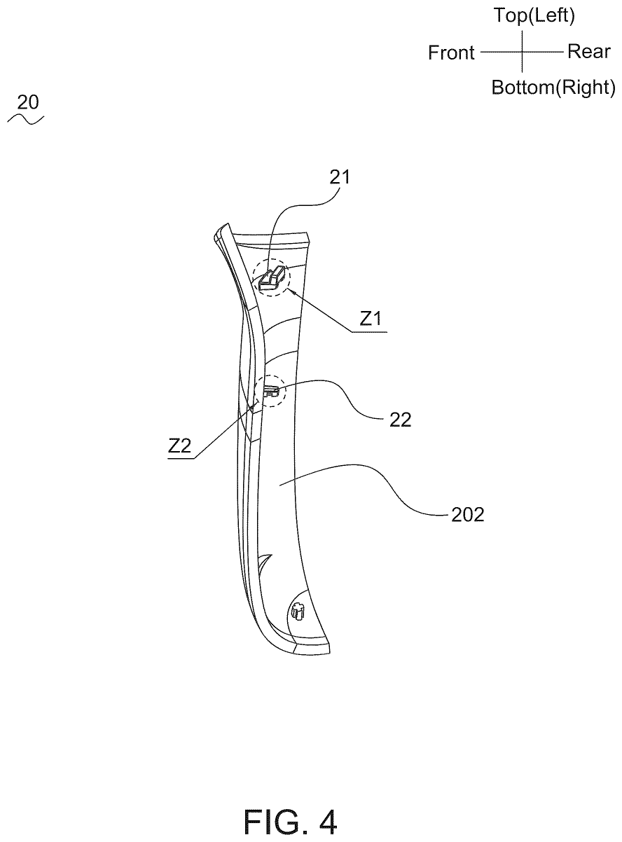

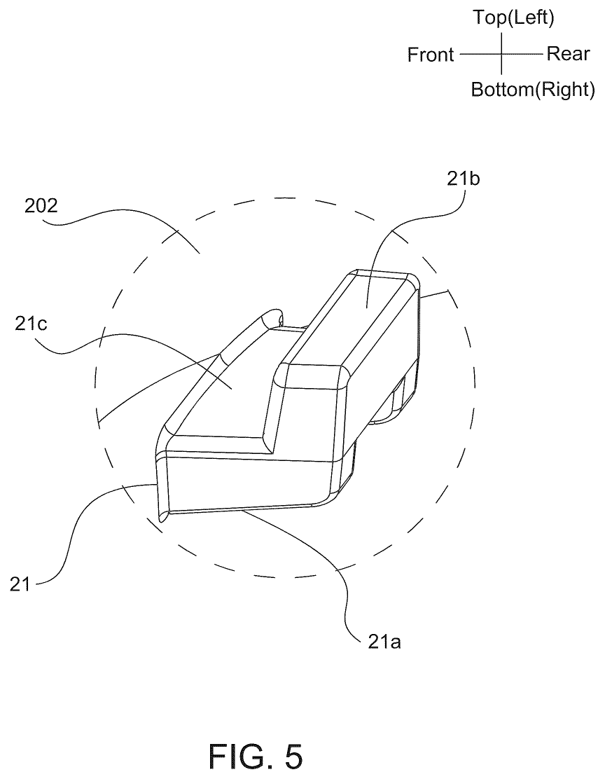

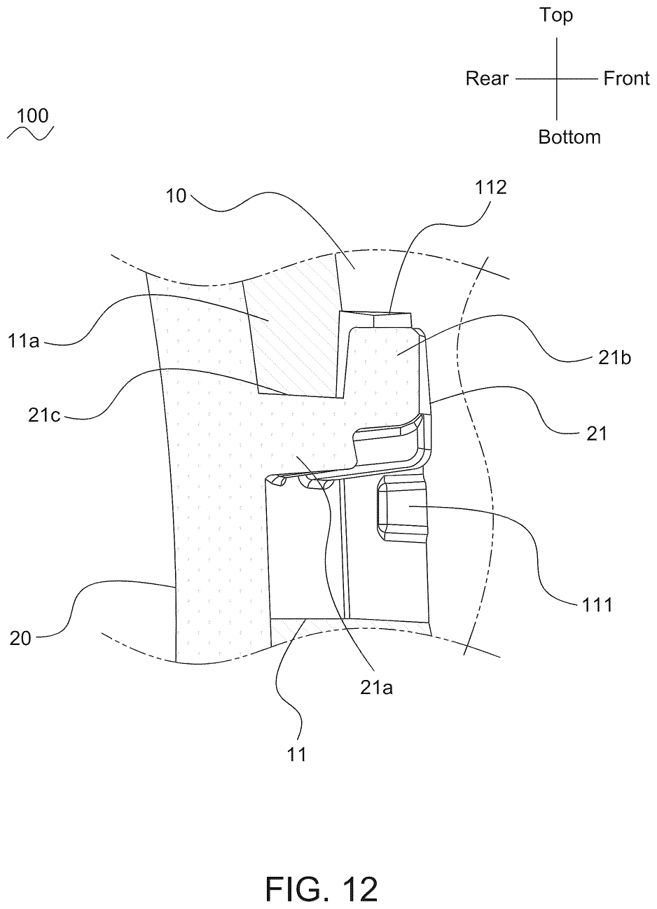

Referring to FIG. 4, FIG. 5 and FIG. 12, an inside of the battery cover 20 has an inner wall 202. The first elastic buckling portion 21 and the second elastic buckling portion 22 are protruded inward from the inner wall 202 of the battery cover 20. The first elastic buckling portion 21 is parallel to the second elastic buckling portion 22. The first elastic buckling portion 21 is shown as a lying L shape. The first elastic buckling portion 21 has a buckling arm 21a, a limiting arm 21b and a limiting groove 21c. The buckling arm 21a is extended inward from the inner wall 202 of the battery cover 20. The limiting arm 21b is extended upward from a tail end of the buckling arm 21a. The limiting groove 21c is formed between the buckling arm 21a and the limiting arm 21b. The limiting groove 21c is recessed downward from an inner portion of a top of the first elastic buckling portion 21. A width of the first elastic buckling portion 21 is approximate to a width of the first assembling hole 11. The width of the first elastic buckling portion 21 is approximate to a distance between the inner surface of the left side wall 11c of the first assembling hole 11 and an inner surface of the right side wall 11d of the first assembling hole 11. After the first elastic buckling portion 21 is buckled in the first assembling hole 11, the buckling arm 21a is fastened between the first buckling block 111 and the top wall 11a of the first assembling hole 11. The limiting arm 21b extends into the recess 112. The limiting arm 21b is limited in the recess 112.

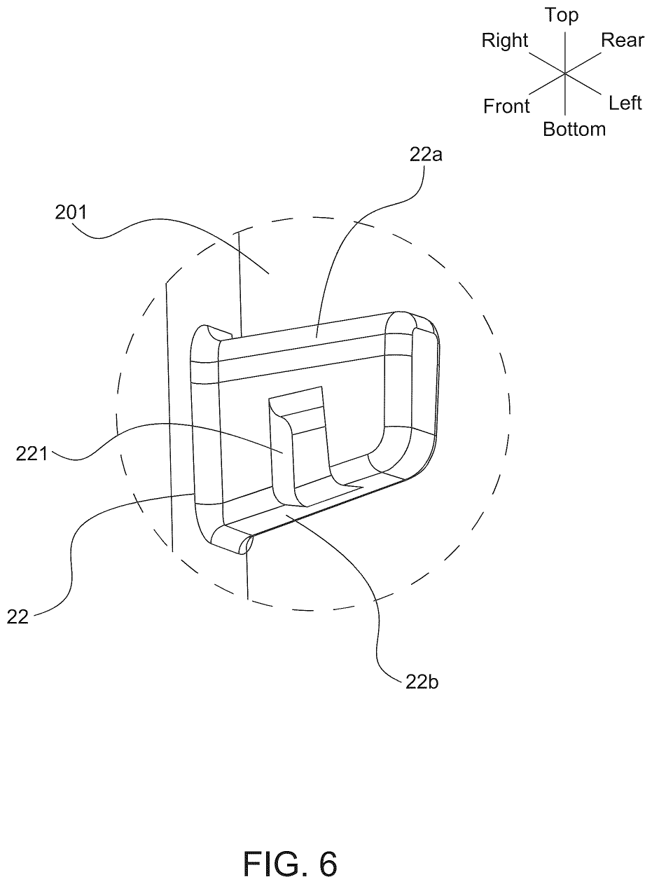

Referring to FIG. 6 and FIG. 13, the second elastic buckling portion 22 is shown as a substantially cuboid shape. The second elastic buckling portion 22 has an outer surface 22a and a bottom surface 22b. A middle of the outer surface 22a of the second elastic buckling portion 22 are recessed inward to form a clamping slot 221 penetrating through the bottom surface 22b. In the preferred embodiment, a shape of the clamping slot 221 is similar to a shape of the long protruding block 121a.

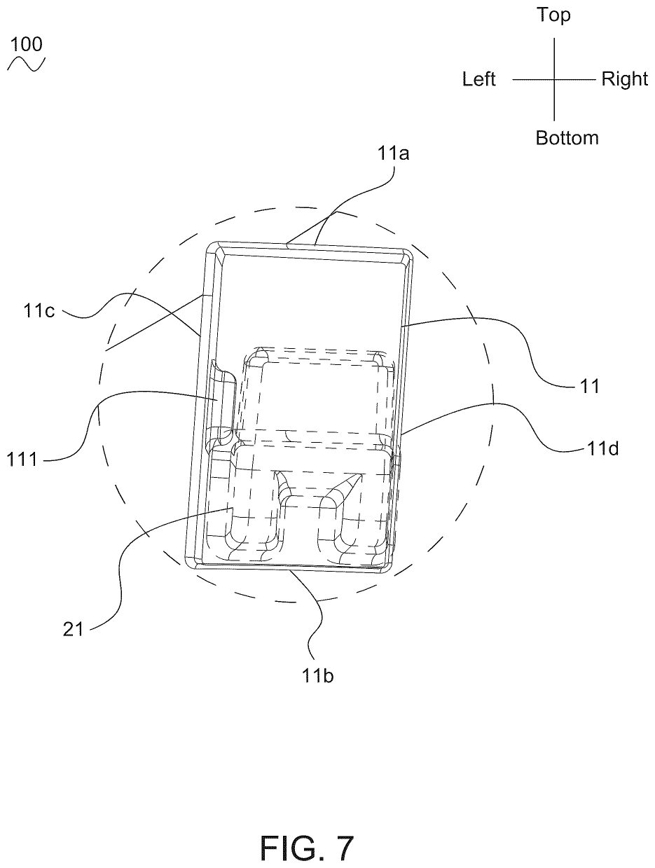

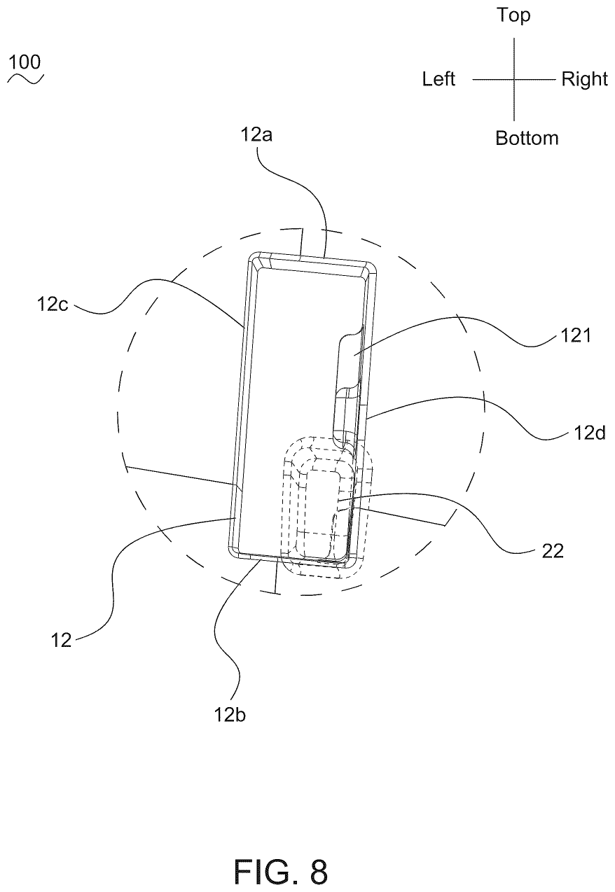

Referring to FIG. 7 and FIG. 8, in the preferred embodiment, the battery cover 20 is made of an elastic material, such as a plastic material. When the battery cover 20 is assembled to the electronic device 200, the first elastic buckling portion 21 and the second elastic buckling portion 22 pass through the first assembling hole 11 and the second assembling hole 12, respectively, and then the first elastic buckling portion 21 and the second elastic buckling portion 22 slide upward. During a sliding period of the battery cover 20, the first buckling block 111 is disposed to be protruded to a moving path of the first elastic buckling portion 21, and the second buckling block 121 is disposed to be protruded to a moving path of the second elastic buckling portion 22, in that case, the first elastic buckling portion 21 is interfered with the first buckling block 111, and the second elastic buckling portion 22 is interfered with the second buckling block 121, so that the first elastic buckling portion 21 generates a slight deformation, and the second elastic buckling portion 22 generates a slight deformation.

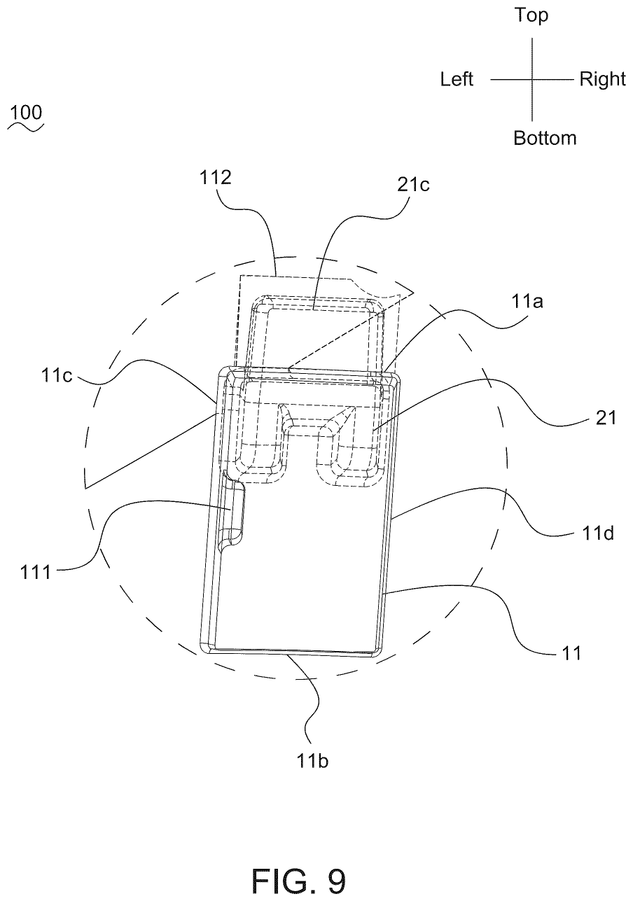

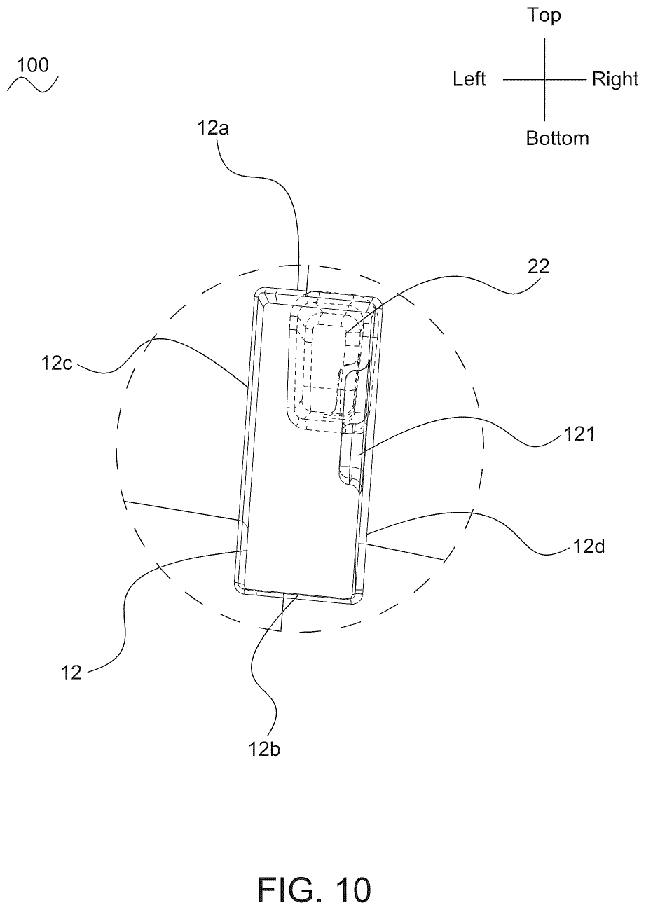

Referring to FIG. 9 to FIG. 13, when the first elastic buckling portion 21 completely passes across the first buckling block 111, a bottom of the first elastic buckling portion 21 abuts against the first buckling block 111, and the top of the first elastic buckling portion 21 is buckled in the recess 112, specifically, the limiting arm 21b of the first elastic buckling portion 21 slides into the recess 112, the first buckling block 111 tightly abuts against a bottom of the buckling arm 21a of the first elastic buckling portion 21, the first elastic buckling portion 21 restores from the slight deformation to an original status, the first elastic buckling portion 21 hooks the top wall 11a of the first assembling hole 11 and the first elastic buckling portion 21 hooks in the recess 112, so that an up-down movement of the battery cover 20 and a front-rear movement of the battery cover 20 are limited.

The long protruding block 121a of the second buckling block 121 slides into the clamping slot 221, the second elastic buckling portion 22 restores from the slight deformation to an initial status, the long protruding block 121a of the second buckling block 121 is buckled in the clamping slot 221, a bottom of the second elastic buckling portion 22 abuts against the second buckling block 121, the short protruding block 121b tightly abuts against the bottom surface 22b of the second elastic buckling portion 22, and the second elastic buckling portion 22 is buckled in the second assembling hole 12, so that the front-rear movement of the battery cover 20 and the up-down movement of the battery cover 20 are limited. The first elastic buckling portion 21 passes through the first assembling hole 11, and the second elastic buckling portion 22 passes through the second assembling hole 12, so that a left-right movement of the battery cover 20 is limited. Due to structural designs of the battery holder 10 and the battery cover 20, the front-rear movement of the battery cover 20, the left-right movement of the battery cover 20 and the up-down movement of the battery cover 20 are all limited, so that the battery cover 20 is stably fastened to the battery holder 10.

As described above, the first elastic buckling portion 21 and the second elastic buckling portion 22 of the inner wall 202 of the battery cover 20, the first assembling hole 11 having the first buckling block 111, and the second assembling hole 12 having the second buckling block 121 are defined as fastening structures, so a combination of the first elastic buckling portion 21 and the first assembling hole 11, and a combination of the second elastic buckling portion 22 and the second assembling hole 12 limit movements of the battery cover 20 along multiple directions. Furthermore, the combination of the first elastic buckling portion 21 and the first assembling hole 11, and the combination of the second elastic buckling portion 22 and the second assembling hole 12 are without being limited to be disposed to other positions of the embedded battery cartridge 100 which are different from the embedded battery cartridge 100 according to the preferred embodiment of the present invention, so the embedded battery cartridge 100 flexibly adjusts a disposing position of the combination of the first elastic buckling portion 21 and the first assembling hole 11, and a disposing position of the combination of the second elastic buckling portion 22 and the second assembling hole 12 according to a need of the electronic device 200 to appropriate for different appearances of the electronic devices 200. As a result, the embedded battery cartridge 100 is capable of disposing positions more flexibly.

Though the present invention is disclosed as the above-mentioned embodiment, the embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. An embedded battery cartridge integrated into an electronic device, the embedded battery cartridge comprising:
a battery holder, an outer surface of the battery holder being recessed inward to form a receiving space, the battery holder opening a first assembling hole disposed at a left side of the battery holder, and a second assembling hole disposed at a right side of the battery holder, the first assembling hole penetrating through the battery holder along a front-rear direction, the second assembling hole penetrating through the battery holder along the front-rear direction, the first assembling hole being surrounded by a top wall, a bottom wall opposite to the top wall, a left side wall and a right side wall opposite to each other, the second assembling hole being surrounded by an upper wall, a lower wall opposite to the upper wall, a left lateral wall and a right lateral wall opposite to each other, the battery holder defining a first buckling block protruded inward from a middle of an inner surface of the left side wall of the first assembling hole, the battery holder defining a second buckling block protruded inward from a middle of an inner surface of the right lateral wall of the second assembling hole, a rear surface of the top wall of the first assembling hole being recessed inward and frontward to form a recess, the recess extending to a top of the first assembling hole, the recess being communicated with the first assembling hole; and
a battery cover detachably fastened to the battery holder, the battery cover covering the receiving space, an inside of the battery cover having an inner wall, the battery cover having a first elastic buckling portion and a second elastic buckling portion protruded inward from the inner wall of the battery cover, the first elastic buckling portion having a buckling arm extended inward from the inner wall of the battery cover, and a limiting arm extended upward from a tail end of the buckling arm, the buckling arm being fastened between the first buckling block and the top wall of the first assembling hole, the limiting arm being limited in the recess, the second elastic buckling portion having an outer surface and a bottom surface, a middle of the outer surface of the second elastic buckling portion being recessed inward to form a clamping slot penetrating through the bottom surface, the second buckling block having a long protruding block disposed along an up-down direction, and a short protruding block extended frontward from a front of a lower portion of the long protruding block, the long protruding block of the second buckling block being buckled in the clamping slot, the short protruding block tightly abutting against the bottom surface of the second elastic buckling portion.

2. The embedded battery cartridge as claimed in claim 1, wherein the first elastic buckling portion is shown as a lying L shape.

3. The embedded battery cartridge as claimed in claim 1, wherein a width of the first elastic buckling portion is approximate to a distance between the inner surface of the left side wall of the first assembling hole and an inner surface of the right side wall of the first assembling hole.

4. The embedded battery cartridge as claimed in claim 1, wherein the second elastic buckling portion is shown as a substantially cuboid shape.

5. The embedded battery cartridge as claimed in claim 1, wherein the first elastic buckling portion is buckled in the first assembling hole, the second elastic buckling portion is buckled in the second assembling hole.

6. The embedded battery cartridge as claimed in claim 1, wherein the battery cover is made of an elastic material.

7. The embedded battery cartridge as claimed in claim 1, wherein the first elastic buckling portion hooks the top wall of the first assembling hole and the first elastic buckling portion hooks in the recess.

8. An embedded battery cartridge, comprising:
a battery holder;
a first assembling hole disposed at a left side of the battery holder, the first assembling hole penetrating through the battery holder along a front-rear direction;
a second assembling hole disposed at a right side of the battery holder, the second assembling hole penetrating through the battery holder along the front-rear direction;
a first buckling block protruded inward from an inner surface of a left side wall of the first assembling hole;
a second buckling block protruded inward from an inner surface of a right lateral wall of the second assembling hole;
a recess, a rear surface of a top wall of the first assembling hole being recessed inward and frontward to form the recess extending to a top of the first assembling hole, the recess being communicated with the first assembling hole;
a battery cover detachably fastened to a front of the battery holder, an inside of the battery cover having an inner wall;
a first elastic buckling portion protruded inward from the inner wall of the battery cover, the first elastic buckling portion having a limiting groove recessed downward from an inner portion of a top of the first elastic buckling portion; and
a second elastic buckling portion protruded inward from the inner wall of the battery cover;
wherein the first elastic buckling portion is buckled in the first assembling hole, a bottom of the first elastic buckling portion abuts against the first buckling block, and the top of the first elastic buckling portion is buckled in the recess; and
wherein the second elastic buckling portion is buckled in the second assembling hole, a bottom of the second elastic buckling portion abuts against the second buckling block.

9. The embedded battery cartridge as claimed in claim 8, wherein the first elastic buckling portion is shown as a lying L shape.

10. The embedded battery cartridge as claimed in claim 8, wherein the first elastic buckling portion has a buckling arm, and a limiting arm extended upward from a tail end of the buckling arm, the buckling arm is fastened between the first buckling block and the top wall of the first assembling hole, the limiting arm is limited in the recess.

11. The embedded battery cartridge as claimed in claim 8, wherein a width of the first elastic buckling portion is approximate to a width of the first assembling hole.

12. The embedded battery cartridge as claimed in claim 8, wherein the second elastic buckling portion is shown as a substantially cuboid shape.

13. The embedded battery cartridge as claimed in claim 8, wherein the second elastic buckling portion has an outer surface and a bottom surface, a middle of the outer surface of the second elastic buckling portion is recessed inward to form a clamping slot penetrating through the bottom surface, the second buckling block has a long protruding block disposed along an up-down direction, and a short protruding block extended frontward from a front of a lower portion of the long protruding block, the long protruding block of the second buckling block is buckled in the clamping slot, the short protruding block tightly abuts against the bottom surface of the second elastic buckling portion.

14. An embedded battery cartridge, comprising:
a battery holder;
a first assembling hole penetrating through the battery holder along a front-rear direction;
a second assembling hole penetrating through the battery holder along the front-rear direction;
a first buckling block protruded inward from an inner peripheral wall of the first assembling hole, and the first buckling block protruding into the first assembling hole;
a second buckling block protruded inward from an inner peripheral wall of the second assembling hole, and the second buckling block protruding into the second assembling hole;
a recess, a rear surface of a top wall of the first assembling hole being recessed inward and frontward to form the recess extending to a top of the first assembling hole, the recess being communicated with the first assembling hole;
a battery cover detachably fastened to a front of the battery holder;
a first elastic buckling portion protruded inward from an inner wall of the battery cover, the first elastic buckling portion being buckled in the first assembling hole, the first elastic buckling portion having a buckling arm extended inward from the inner wall of the battery cover, and a limiting arm extended upward from a tail end of the buckling arm, the buckling arm being fastened between the first buckling block and the top wall of the first assembling hole, the limiting arm being limited in the recess; and
a second elastic buckling portion protruded inward from the inner wall of the battery cover, the second elastic buckling portion being buckled in the second assembling hole, a bottom of the second elastic buckling portion abutting against the second buckling block.
